(19) United States
(12) Patent Application Publication
(10) Pub. No.: US 2012/0255129 A1
(43) Pub. Date: Oct. 11, 2012

(54) METHOD, APPARATUS AND SYSTEM FOR LAUNDRY CLEANING

(76) Inventor: Akos JANKURA, St. Petersburg, FL (US)

(21) Appl. No.: 13/080,075

(22) Filed: Apr. 5, 2011

(51) Int. Cl. C11D 17/00; B05D 3/12; D06L 1/20

(52) U.S. Cl. 8/137; 510/283; 510/295; 427/290

(57) ABSTRACT

A sheet for delivery of cleaning substances, including a fabric substrate having a detergent portion and a detergent impregnated into the detergent portion up to the saturation point of the fabric substrate. The sheet may further include a pre-treating portion and a pre-treating solution impregnated into the pre-treating portion up to the saturation point of the fabric substrate. The detergent may further include naturally derived compounds such as plant based hydrocarbons and oleo alcohol ethoxylates.

### BACKGROUND

Generally, methods of cleaning laundry in an automatic washing machine necessitate the use of a detergent to aid in stain removal and washing of the laundry articles. Detergents frequently come in the form of a liquid or a powder that needs to be transferred from a separate container into the interior of the washing machine. Such methods of delivering detergent to laundry loads frequently result in spills, and, moreover, require the measuring of detergent by the user via a separate detergent receptacle, necessitating additional effort and raising the chances of spillage.

Certain solutions to the above issues are known in the art, such as, for example, pouches containing liquid or powdered detergents, tablets formed from compacted detergent substances, and sheets that are impregnated with detergent substances. However, pouches and tablets commonly results in incomplete solubility of the detergent due to limited surface area or clumping of the detergent substances. Incomplete solubility may result in suboptimal cleaning effect of the laundry articles as well as the deposition of detergent clumps on the laundry articles. Detergent-impregnated sheets commonly fail to deliver a detergent load that is sufficient for cleaning the laundry articles and also result in redeposition, incomplete solubility, and leftover surfactant residue on the laundry articles. Furthermore, common detergent ingredients are frequently harmful to the environment and must be processed by waste treatment plants or landfills, due, in part, to the fillers incorporated by many detergents.

Additionally, the above-described detergents and detergent delivery methods generally do not include the ability to pre-treat the articles prior to laundry, necessitating the additional use of separate detergents and detergent delivery methods.

### SUMMARY

In one exemplary embodiment, a sheet for delivery of cleaning substances, is disclosed. The sheet may include a fabric substrate having a detergent portion and a detergent impregnated into the detergent portion up to the saturation point of the fabric substrate. The sheet may further include a pre-treating portion and a pre-treating solution impregnated into the pre-treating portion up to the saturation point of the fabric substrate. The detergent may include naturally derived compounds such as plant based hydrocarbons and oleo alcohol ethoxylates.

In another exemplary embodiment, a method of laundry cleaning is disclosed. The method may include pre-treating laundry articles with a portion of a sheet for delivery of cleaning substances, depositing the sheet and the laundry articles into a washing machine and operating the washing machine.

In another exemplary embodiment, a method of manufacturing a sheet for delivery of cleaning substances is disclosed. The method may include perforating a continuous substrate sheet, separating the continuous substrate sheet into a plurality of smaller sheets, impregnating a first portion of each of the smaller sheets with a detergent solution, and impregnating a second portion of each of the smaller sheets with a pre-treating solution.

### BRIEF DESCRIPTION OF THE FIGURES

FIG. 1 shows an exemplary embodiment of a sheet for delivery of cleaning substances.

FIG. 2 shows another exemplary embodiment of a sheet for delivery of cleaning substances.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

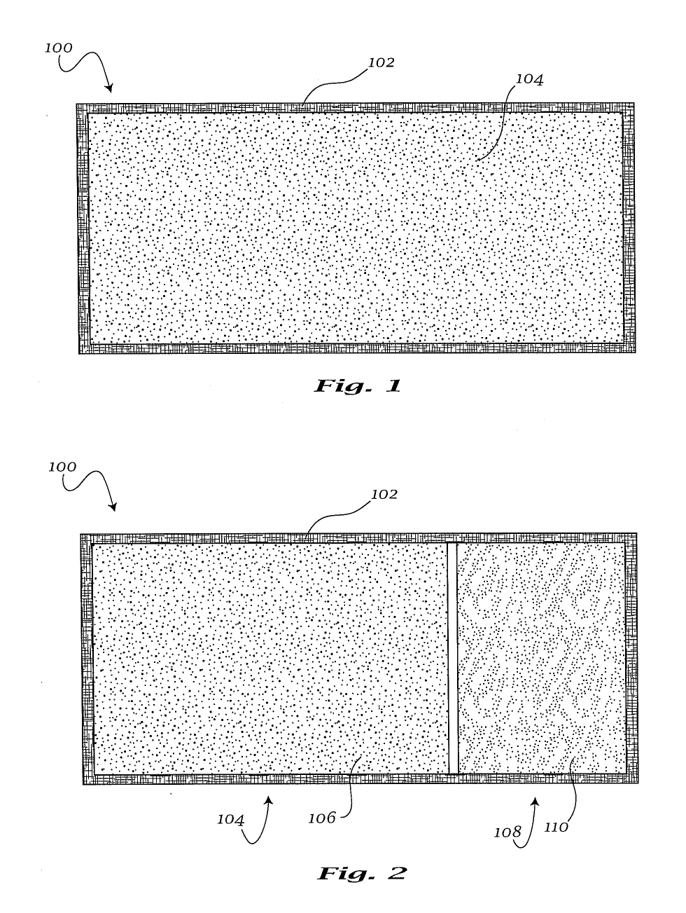

Referring to FIG. 1, according to at least one exemplary embodiment, a sheet 100 for detergent delivery is provided. Sheet 100 may include a substrate 102, and a laundry detergent 104 infused, embedded, impregnated, or otherwise disposed within or on the surface of substrate 102. In one embodiment, substrate 102 may be a hydraulically entangled nonwoven fibrous material having a nominal thickness between approximately 15 mils and approximately 30 mils. For example, substrate 102 may be similar to SONTARA 8005, which is a spunlaced fabric composed of polyester and having a nominal thickness of approximately 22 mils. In other embodiments, substrate 102 may be a fabric material, open cell rubber, foam sheet, or any other material known to one having ordinary skill in the art that is capable of having a detergent infused therein.

Laundry detergent 104 may be disposed within substrate 102. The amount of laundry detergent 104 disposed within substrate 102 may vary depending on the saturation point of a particular substrate 102 in relation to a particular detergent 104, as well as other characteristics of substrate 102 and detergent 104 that are familiar to one having ordinary skill in the art. In one embodiment, the amount of detergent 104 disposed within substrate 102 may be such that a single sheet 100 is suitable for providing a sufficient detergent load to an automatic washing machine. For example, each sheet 100 may include between approximately 0.3 and 0.6 ounces of detergent per sheet. In one exemplary embodiment, a sheet 100 may include approximately 0.4 ounces of detergent. Detergent 102 may have a “dry hand,” that is, detergent 102 may be dry to the touch.

The composition of laundry detergent 102 may include a plurality of chemical compounds. Such compounds may be selected from a range of non-ionic surfactants, such as, for example, alcohol ethoxylates. Such compounds may further be compliant with current Volatile Organic Compound (VOC) regulations, and may also include compounds that are extracted from natural sources. In one embodiment, the composition of detergent 102 may include alcohol ethoxylates that have been sourced from plant-based hydrocarbons, such as, for example, oleo alcohol ethoxylates. Detergent 102 may further include plant-based oils, such as, for example, banana oil. Detergent 102 may further include other compounds, such as ionic surfactants and laundry enzymes.

The composition of laundry detergent 102 may further include a soil anti-redeposition agent. The soil anti-redeposition agent may reduce the likelihood of redeposition of soil, dirt, and other contaminants on the laundry articles during the laundry process, thereby allowing the user to reduce the amount of bleach used in the laundry process. The composition of laundry detergent 102 may further include, in any combination, builders, complexing agents, surfactants, optical brighteners, oxidizing agents, alkaline sources, electrolytes, foam stabilizers, fragrances, color enhances, biocides, corrosion inhibitors, encrustation preventers, enzymes for stain removal, anti-static conditioners and fabric softeners.

Turning to FIG. 2, in one embodiment, a sheet for detergent delivery 200 may include a substrate 202, a detergent portion 204 and a pre-treating portion 208. Substrate 202 may be substantially as described above. Detergent portion 204 and pre-treating portion 208 may both be infused into substrate 202. Detergent portion 204 may include a detergent 206 substantially as described above. Pre-treating portion 208 may include a pre-treating solution 210 or any chemical composition that may be applied to laundry articles or stained portions of laundry articles prior to washing the laundry articles in water. Pre-treating solution 210 may have a “wet hand,” that is, pre-treating solution 210 may be moist or wet to the touch. Pre-treating solution 210 may be formulated to contain spotting agents and stain removing agents such that stained portions of laundry articles may be cleaned by applying and rubbing pre-treating portion 206 on a stained portion of a laundry article.

In an exemplary method of using sheet 100, the user may place at least one sheet 100 into a washing machine together with laundry articles. Water may then be applied to sheet 100 as the washing machine is filled with water. Detergent 104 and the constituent components thereof may then solubilize off substrate 102 and sheet 100 during the washing process while sheet 100 remains insoluble.

In an exemplary method of using sheet 200, the user may apply pre-treating portion 208 to a portion of a laundry article or a stain disposed on the laundry article prior to the washing process. Pre-treating portion 208 may be applied by dabbing, rubbing, blotting, or any similar action. The constituent components of pre-treating solution 210 may then transfer to the laundry article until the portion of the laundry article is partially or fully saturated with pre-treating solution 210. The constituent components of pre-treating solution 210 may then act to isolate and break up the stain disposed on the laundry article. The user may then place sheet 200 into a washing machine together with the laundry article and other laundry articles. Water may then be applied to sheet 200 as the washing machine is filled with water. Detergent 206 and the constituent components thereof may then solubilize off detergent portion 204 of sheet 200 during the washing process while sheet 200 remains insoluble.

In an exemplary method of manufacturing a sheet for detergent delivery, a continuous sheet of substrate may be perforated to create a plurality of sheets having a desired size and roll count. The fabric substrate may then be wound into rolls and the rolls may be placed into containers. In another embodiment, the sheets may be separated and disposed individually in containers. Containers of sheets or rolls of sheets may then be placed into a liquid feeder tray and transferred to a liquid fill station, where a desired amount of a first solution containing the detergent and the constituent components thereof may be applied to the containers. The first solution may then be infused, embedded, impregnated, or otherwise disposed within or on the surface of the substrate such that the substrate is saturated with the solution. In another embodiment, the first solution may be infused, embedded, impregnated, or otherwise disposed within or on the surface of the detergent portion of the sheet such that the detergent portion of the substrate is saturated with the solution. The sheet may then be transferred to another liquid fill station, where a second solution containing the pre-treating solution may be infused, embedded, impregnated, or otherwise disposed within the pre-treating portion of the substrate. Rolls of sheets or individual sheets may then be sealed and packaged as desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A sheet for delivery of cleaning substances, comprising:
a fabric substrate further comprising a detergent portion; and
a detergent impregnated into the detergent portion of the fabric substrate up to the saturation point of the fabric substrate.

2. The sheet of claim 1, wherein the fabric substrate is a hydraulically entangled nonwoven fibrous material.

3. The sheet of claim 2, wherein the fabric substrate is a polyester spunlaced fabric.

4. The sheet of claim 1, wherein the fabric substrate has a nominal thickness between approximately 15 mils and approximately 30 mils.

5. The sheet of claim 4, wherein the fabric substrate has a nominal thickness of approximately 22 mils.

6. The sheet of claim 1, wherein the detergent comprises naturally derived compounds.

7. The sheet of claim 6, wherein the naturally derived compounds are plant-based hydrocarbons.

8. The sheet of claim 6, wherein the detergent further comprises alcohol ethoxylates.

9. The sheet of claim 8, wherein the alcohol ethoxylates comprise oleo alcohol ethoxylates.

10. The sheet of claim 7, wherein the detergent further comprises banana oil.

11. The sheet of claim 1, wherein the detergent further comprises soil anti-redeposition agents.

12. The sheet of claim 1, wherein the fabric substrate further comprises:
a pre-treating portion; and
a pre-treating solution impregnated into the pre-treating portion of the fabric substrate up to the saturation point of the fabric substrate.

13. The sheet of claim 12, wherein the pre-treating portion has a wet hand.

14. The sheet of claim 12, wherein the pre-treating solution comprises spotting agents and stain removing agents.

15. A method for laundry cleaning, comprising:
pre-treating laundry articles with a portion of a sheet having cleaning substances impregnated therein;
depositing the sheet and the laundry articles into a washing machine; and
operating the washing machine.

16. The method of claim 15, wherein the cleaning substances comprise a pre-treating solution and a detergent.

17. The method of claim 16, wherein the detergent comprises oleo alcohol ethoxylates.

18. A method of manufacturing a sheet for delivery of cleaning substances, comprising:
perforating a continuous substrate sheet;
separating the continuous substrate sheet into a plurality of smaller sheets;
impregnating a first portion of each of the smaller sheets with a detergent solution; and
impregnating a second portion of each of the smaller sheets with a pre-treating solution.

19. The method of claim 18, wherein:
the first portion of each of the smaller sheets has a dry hand; and
the second portion of each of the smaller sheets has a wet hand.

20. The method of claim 18, wherein the detergent solution comprises oleo alcohol ethoxylates.
